(19) United States
(12) Patent Application Publication
(10) Pub. No.: US 2025/0093114 A1
(43) Pub. Date: Mar. 20, 2025

(54) COMPOSITE HEAT EXCHANGER FOR ELECTRIC VEHICLE

(71) Applicant: Hanon Systems, Daejeon (KR)

(72) Inventors: Sang Ouk LEE, Daejeon (KR); Hyunkeun SHIN, Daejeon (KR); Hong-Young LIM, Daejeon (KR); Gwang Ok KO, Daejeon (KR); Sung Hong SHIN, Daejeon (KR); Jong Chan LEE, Daejeon (KR); Ji Hun HAN, Daejeon (KR)

(21) Appl. No.: 18/570,120

(22) PCT Filed: Dec. 5, 2022
(86) PCT No.: PCT/KR2022/019595

§ 371 Date: Dec. 14, 2023

(30) Foreign Application Priority Data
Dec. 3, 2021 (KR) 10-2021-0172080

(51) Int. Cl. F28F 9/00; F28D 1/053; F28D 21/00; F28F 1/32

(52) U.S. Cl. CPC F28F 9/005; F28D 1/05316; F28F 1/32; F28D 2021/0084

(57) ABSTRACT

The present invention relates to a composite heat exchanger for an electric vehicle. The objective of the present invention is to provide an integrated composite heat exchanger that allows a plurality of heat exchange media to be distributed in each area, and to provide a composite heat exchanger for an electric vehicle that obtains effects, by means of integration, such as reducing the number of components and the number of processes, improving refrigerant flow characteristics, and improving cooling efficiency, and in addition, the problem of concentration of thermal stress caused by the integration of the heat exchanger is resolved by means of improving the shape of the area boundary.

### TECHNICAL FIELD

The present invention relates to a composite heat exchanger, and more particularly, to a composite heat exchanger in which a condenser, a receiver dryer, and a radiator are integrated in an air conditioning system for an electric vehicle.

### BACKGROUND ART

In general, not only components such as an engine for operating a vehicle are provided in an engine room of the vehicle, but also various heat exchangers such as a radiator, an intercooler, an evaporator, and a condenser for cooling the components such as the engine in the vehicle or adjusting an air temperature in an interior of the vehicle are provided in the engine room of the vehicle. In general, heat exchange media flow in the heat exchangers. The heat exchange medium in the heat exchanger exchanges heat with outside air present outside the heat exchanger, such that the cooling operation or the heat dissipation is performed.

The condenser is a heat exchanger responsible for condensation in a main refrigeration cycle in an air conditioning system for a vehicle and serves to condense a high-temperature, high-pressure gaseous refrigerant into a liquid state. Meanwhile, the radiator serves to cool a drive device by allowing a high-temperature coolant, which is made by absorbing heat, to exchange heat with outside air. Because both the condenser and the radiator define relatively high-temperature environments as described above, the condenser and the radiator are often disposed in parallel and side by side in a forward/rearward direction at the time of configuring a cooling module. FIG. 1 is a view illustrating a part of the cooling module. It can be ascertained that a condenser 1 and a radiator 2 are tightly disposed in parallel and side by side in the forward/rearward direction. Meanwhile, in case that the drive device is an internal combustion engine, a temperature of a coolant is significantly high. In contrast, in case that the drive device is an electric motor, a temperature of a coolant is relatively low because the amount of heat generation is much less than that in the internal combustion engine. Therefore, particularly in the case of the electric vehicle, operating temperature ranges become significantly close to each other, such that the condenser and the radiator are sometimes integrated into a multi-row exchanger. In case that the drive device is a hybrid drive device that uses both the internal combustion engine and the electric motor, both the internal combustion engine and the electric motor are cooled by coolants, but the coolant for the internal combustion engine has a much higher temperature than the coolant for the electric motor. Therefore, a high-temperature radiator and a low-temperature radiator are sometimes operated independently. The high-temperature radiator and the low-temperature radiator are also integrated into a multi-row heat exchanger.

In the heat exchanger, i.e., the multi-row integrated heat exchanger, heat exchangers, which allow heat exchange media having different operating temperature ranges to flow into separated areas, are collectively called composite heat exchangers. The composite heat exchanger basically reduces a volume of a cooling module, which is significantly advantageous in improving spatial utilization of an engine room. Furthermore, even though the same composite heat exchanger is used, the heat exchange media, which flow to the respective areas, may be variously changed to a refrigerant, a coolant, a high-temperature coolant, a low-temperature coolant, and the like in accordance with the user's necessity, which advantageously leads to high compatibility.

The use of the composite heat exchanger increases by virtue of the above-mentioned advantages, but there is a disadvantage associated with the operational characteristics of the composite heat exchanger. As described above, in the composite heat exchanger, the operating temperature ranges between the heat exchange media vary depending on the areas. In this case, there occurs a problem in that because of a difference in thermal expansion degrees between materials of the heat exchanger, thermal stress is concentrated on boundaries between the areas in which the heat exchange media flow. Because the concentration of thermal stress and damage due to the concentration of thermal stress cause significant deterioration in durability and lifespan of the heat exchanger, there is a need for a solution for coping with the concentration of thermal stress.

Meanwhile, a high-temperature, high-pressure gaseous refrigerant is introduced into the condenser and emits condensation heat to the outside, the gaseous refrigerant is condensed into a liquid refrigerant, and then the liquid refrigerant is discharged. The liquid refrigerant discharged from the condenser is moved to and temporarily stored in a receiver dryer, and then delivered to an expansion valve by the amount required for a cooling load. In this case, the refrigerant discharged from the condenser may be in a state in which the gaseous refrigerant and the liquid refrigerant are mixed instead of a perfect liquid state. In case that the refrigerant in the gas-liquid mixed state is delivered to the expansion valve, there is concern that system efficiency deteriorates. In order to solve the above-mentioned problem, a filter device is typically provided in the receiver dryer in order to remove bubbles, moisture, and the like mixed in the liquid refrigerant. Korean Patent No. 2121816 (“RECEIVER DRYER CAP FILTER AND METHOD OF ASSEMBLING THE SAME,” Jun. 5, 2020) and the like disclose functions of receiver dryers, structures of filter devices, and the like.

As illustrated in FIG. 1, a receiver dryer 3 is configured as a separate component provided independently of a condenser 1. In this case, a separate coupling means 4 is required to connect the receiver dryer 3 to the condenser 1. The coupling means 4 causes an increase in the number of components in the overall device. In addition, according to the above-mentioned configuration, an assembling process is naturally required to couple the condenser 1 and the receiver dryer 3, and the number of processes also increases. In addition, in case that the condenser 1 is provided in the form of a multi-row heat exchanger, a separate pipe 5 is provided to deliver the refrigerant from the condenser 1 to the receiver dryer 3, which causes a problem in that the amount of pressure drop of the refrigerant increases while the refrigerant passes through the pipe 5 elongated unnecessarily. Further, because the receiver dryer 3 in the related art is configured such that a drying agent and the like provided therein cannot be replaced, there is a problem in that the entire receiver dryer 3 needs to be replaced when the drying agent and the like is required to be replaced, which causes an increase in repair costs.

### Document of Related Art

### Patent Document

1. Korean Patent No. 2121816 (“RECEIVER DRYER CAP FILTER AND METHOD OF ASSEMBLING THE SAME,” Jun. 5, 2020)

### DISCLOSURE

### Technical Problem

Accordingly, the present invention has been made in an effort to solve the above-mentioned problem in the related art, and an objective of the present invention is to provide an integrated composite heat exchanger that allows a plurality of heat exchange media to be distributed in each area, and to provide a composite heat exchanger for an electric vehicle that obtains effects, by means of integration, such as reducing the number of components and the number of processes, improving refrigerant flow characteristics, and improving cooling efficiency, and in addition, the problem of concentration of thermal stress caused by the integration of the heat exchanger is resolved by means of improving the shape of the area boundary.

### Technical Solution

In order to achieve the above-mentioned object, the present invention provides a composite heat exchanger 100 including: a plurality of tubes disposed in two front and rear rows; first and second header tanks 141 and 142 connected to two opposite ends of the overall tube rows and each having a partition wall that divides a fluid flow space into a front space and a rear space; a front core FC defined by a front tube row and configured to communicate with the front spaces of the first and second header tanks 141 and 142; and a rear core BC defined by a rear tube row and configured to communicate with the rear spaces of the first and second header tanks 141 and 142, in which a part of the front core FC defines a first heat exchange part 110 in which a coolant flows, in which the remaining part of the front core FC defines a second heat exchange part 120 in which a refrigerant flows, and in which the rear core BC defines a third heat exchange part 130 in which a separate heat exchange medium flows.

In this case, the second heat exchange part 120 of the composite heat exchanger 100 may define a refrigerant supercooling area S in which the refrigerant is supercooled.

In addition, the first heat exchange part 110 of the composite heat exchanger 100 may be defined by a part of an upper side of the front core FC, and the second heat exchange part 120 may be defined by a part of a lower side of the front core FC.

In addition, baffles 160 may be provided in the first and second header tanks 141 and 142 of the composite heat exchanger 100 so that fluid flow spaces for the coolant and the refrigerant are isolated on a boundary position between the first and second heat exchange parts 110 and 120.

In a first embodiment, the baffle 160 may be provided as a plurality of baffles provided on the boundary position between the first and second heat exchange parts 110 and 120 of the composite heat exchanger 100, the plurality of baffles 160 may be spaced apart from one another in extension directions of the first and second header tanks 141 and 142, and a dummy tube DT having a closed interior is provided between the plurality of baffles 160 spaced apart from one another.

In addition, the first and second header tanks 141 and 142 may each have a high-height portion having a relatively high height and a low-height portion having a relatively low height in accordance with a range, the high-height portion may be included in a range corresponding to the first heat exchange part 110, and the low-height portion may be included in a range corresponding to the second heat exchange part 120.

In addition, the first and second header tanks 141 and 142 may each have an inclined portion 145 formed between the high-height portion and the low-height portion and having a height that changes continuously and inclinedly, and the high-height portion and the inclined portion 145 may be included in a range corresponding to the first heat exchange part 110.

In a second embodiment, the refrigerant may flow in the third heat exchange part 130 of the composite heat exchanger 100, and the third heat exchange part 130 may define a refrigerant condensation area C in which the refrigerant is condensed.

In addition, the composite heat exchanger 100 includes a receiver dryer 150 including a receiver inlet path 151 configured to communicate with the rear space of the first header tank 141, and a receiver outlet path 152 configured to communicate with the front space of the first header tank 141, the refrigerant supercooling area S defined by the second heat exchange part 120 and the refrigerant condensation area C defined by the third heat exchange part may be defined as a condenser 210, the first heat exchange part 110 may define a coolant area W in which the coolant is cooled, and the coolant area W may be defined as a radiator 220, and the condenser 210, the radiator 220, and the receiver dryer 150 may be integrated.

In addition, the composite heat exchanger 100 may be formed such that the refrigerant is introduced into a refrigerant inlet path 211 communicating with the rear space of the second header tank 142 and delivered from the rear space of the second header tank 142 to the rear space of the first header tank 141 while passing through the refrigerant condensation area C in the rear core BC, the refrigerant is delivered from the rear space of the first header tank 141 to the front space of the first header tank 141 via the receiver inlet path 151 and the receiver outlet path 152 while passing through the receiver dryer 150, the refrigerant is delivered from the front space of the first header tank 141 to the front space of the second header tank 142 while passing through the refrigerant supercooling area C in the front core, and the refrigerant is discharged to a refrigerant outlet path 212 communicating with the rear space of the second header tank 142.

In addition, the composite heat exchanger 100 is formed such that the coolant is introduced into a coolant inlet path 212 communicating with the front space of the second header tank 142, the coolant is delivered from the front space of the second header tank 142 to the front space of the first header tank 141 while passing through a part of the coolant area W in the front core FC, the coolant is delivered from the front space of the first header tank 141 to the front space of the second header tank 142 while passing through the remaining part of the coolant area W in the front core FC, and the coolant is discharged to a coolant outlet path 222 communicating with the front space of the second header tank 142.

In addition, one side of the receiver outlet path 152 may be connected to a front side of the receiver dryer 150, extend forward, and then be bent vertically, and the other side of the receiver outlet path may be connected to the front space of the first header tank 141.

In a third embodiment, the coolant may flow in the third heat exchange part 130 of the composite heat exchanger 100, and a temperature range of the coolant flowing in the first heat exchange part 110 and a temperature range of the coolant flowing in the third heat exchange part 130 may be different from each other.

In addition, a temperature range of the coolant flowing in the third heat exchange part 130 of the composite heat exchanger 100 may be higher than a temperature range of the coolant flowing in the first heat exchange part 110.

In addition, an external condenser may be connected to the second heat exchange part 120 of the composite heat exchanger 100, the refrigerant condensed in the external condenser may be introduced into the second heat exchange part 120, and the refrigerant may be supercooled.

In addition, the external condenser may be a water-cooled condenser.

In addition, the external condenser may be integrated with an external receiver dryer.

In addition, the receiver dryer 150 may have a filter module 155 having a filter and a drying agent, and the filter module may be detachably provided.

In addition, in the receiver dryer 150, refrigerant inlet and outlet routes on the receiver dryer 150 may be provided in an area range in which the filter module 150 is provided.

In addition, the composite heat exchanger 100 may include an integrated fin interposed between the tubes and extends to the front core FC and the rear core BC.

### Advantageous Effects

According to the present invention, the several heat exchange parts are formed in the composite heat exchanger, the refrigerant and the coolant appropriately flow through the heat exchange parts, as necessary, which may obtain an excellent effect of variously using the single composite heat exchanger. Specifically, for example, the first, second, and third heat exchange parts may be used to cool the coolant, supercool the refrigerant, and condense the refrigerant. As another example, the first, second, and third heat exchange parts may be used to cool the low-temperature coolant, supercool the refrigerant, and cool the high-temperature coolant. Therefore, the first, second, and third heat exchange parts may be variously used in accordance with the user's necessity, thereby improving the spatial utilization in the engine room and realizing the optimal device arrangement and the flow path configuration in accordance with the necessity.

In addition, according to the present invention, the baffle position, the configuration of the dummy tube, the change in height of the header tank, and the configuration of the inclined portion may effectively solve the problem of the concentration of thermal stress caused by a difference in temperature range between the heat exchange media flowing between the heat exchange parts in the composite heat exchanger. Of course, it is possible to basically solve the problem of deterioration in durability and lifespan caused by the concentration of thermal stress.

Further, according to the present invention, in case that the first, second, and third heat exchange parts are respectively used to cool the coolant, supercool the refrigerant, and condense the refrigerant, the receiver dryer may also be integrated. Because the condenser, the radiator, and the receiver dryer are integrated, the volume of the cooling module may be rapidly reduced, and the spatial utilization of the engine room may also be greatly improved. In addition, the productivity may also be greatly improved by excluding the process of assembling a condenser, a radiator, and a receiver dryer in the related art, which is required because the condenser, the radiator, and the receiver dryer are provided as separate components.

Furthermore, in the related art, there is a problem in that the amount of pressure drop of the refrigerant increases during a process in which the refrigerant flows through a pipe separately provided between the condenser and the receiver dryer. In contrast, this problem is basically solved as the length of the connection flow path between the condenser and the receiver dryer is extremely shortened during the process in which all the components according to the present invention are integrated. The increase in amount of pressure drop of the refrigerant causes an adverse effect that degrades cooling efficiency. In contrast, the present invention may suppress the increase in amount of pressure drop of the refrigerant, thereby ultimately improving the cooling efficiency.

### BRIEF DESCRIPTION OF THE DRAWINGS

FIG. 1 is a view of an arrangement configuration of a condenser, a radiator, and a receiver dryer in the related art.

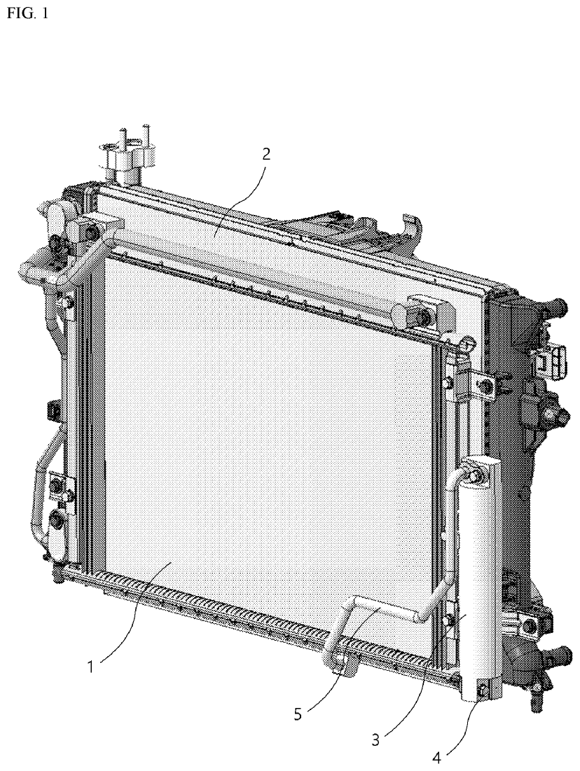

FIG. 2 is a schematic configuration view of a composite heat exchanger of the present invention.

FIG. 3 is a view of a first embodiment of the composite heat exchanger of the present invention.

FIG. 4 is an enlarged view of a part in the vicinity of an inclined portion of the first embodiment of the composite heat exchanger of the present invention.

FIG. 5 is a view of a detailed configuration in the vicinity of the inclined portion of the first embodiment of the composite heat exchanger of the present invention.

FIG. 6 is a schematic configuration view of a second embodiment of the composite heat exchanger of the present invention.

FIG. 7 is a view of the second embodiment of the composite heat exchanger of the present invention.

FIG. 8 is a front perspective view of the second embodiment of the composite heat exchanger of the present invention.

FIG. 9 is a rear perspective view of the second embodiment of the composite heat exchanger of the present invention.

FIG. 10 is a top plan view of the second embodiment of the composite heat exchanger of the present invention.

FIG. 11 is a front perspective view of a part of a receiver dryer.

FIG. 12 is a side view of a part of the receiver dryer.

FIG. 13 is a rear perspective cross-sectional view of a part of the receiver dryer.

FIG. 14 is a detailed view of a tank part.

FIG. 15 is a schematic configuration view of a third embodiment of the composite heat exchanger of the present invention.

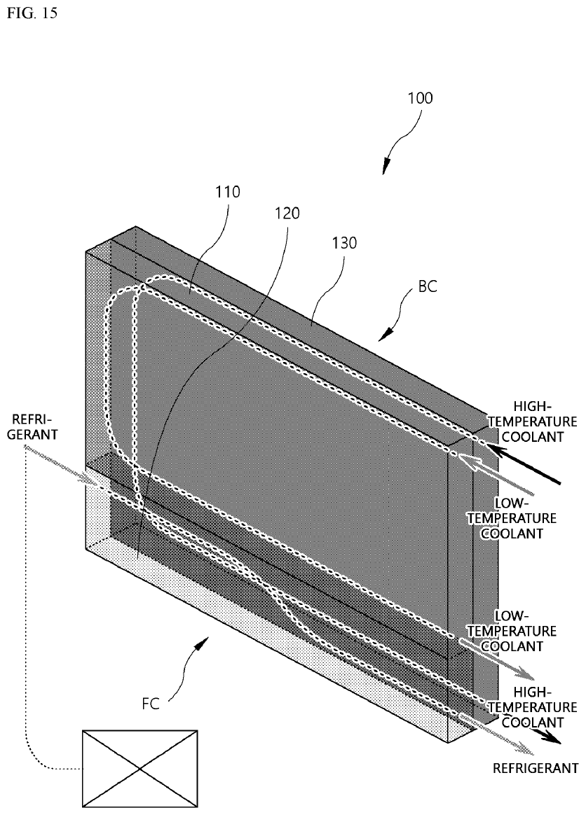

### DESCRIPTION OF REFERENCE NUMERALS

100: Composite heat exchanger
110: First heat exchange part
120: Second heat exchange part
130: Third heat exchange part
141: First header tank
142: Second header tank
FC: Front core
BC: Rear core
DT: Dummy tube
150: Receiver dryer
151: Receiver inlet path
152: Receiver outlet path
160: Baffle
165: Flow path baffle
210: Condenser
215: Refrigerant tank part
211: Refrigerant inlet path
212: Refrigerant outlet path
220: Radiator
225: Coolant tank part
221: Coolant inlet path
222: coolant outlet path
C: Refrigerant condensation area
S: Refrigerant supercooling area
W: Coolant area

### MODE FOR INVENTION

Hereinafter, a composite heat exchanger according to the present invention configured as described above will be described in detail with reference to the accompanying drawings.

### [1] First Embodiment: Overall Configuration

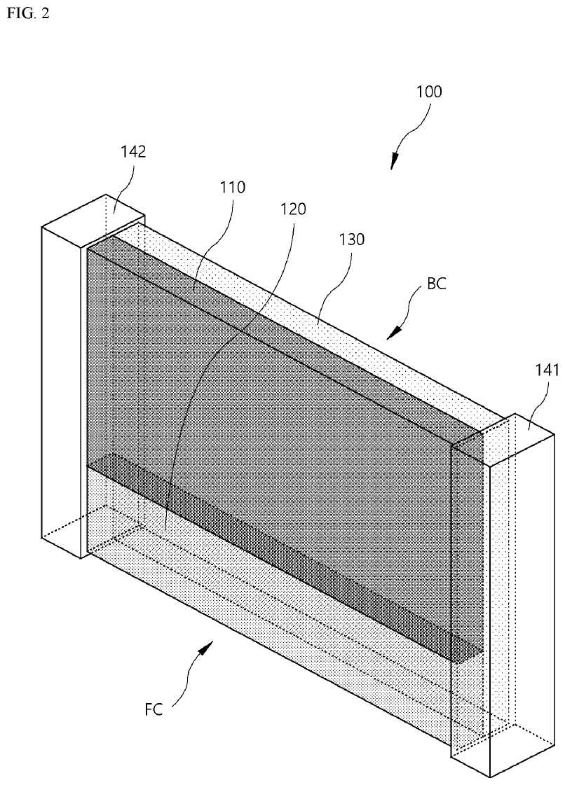

FIG. 2 is a schematic configuration view of a composite heat exchanger of the present invention. First, an overall configuration of a composite heat exchanger 100 of the present invention will be described with reference to FIG. 2.

In view of component configurations, the composite heat exchanger 100 of the present invention includes a plurality of tubes disposed in two front and rear rows (the tubes and the tube rows are omitted in FIG. 2 to simplify the drawings), and first and second header tanks 141 and 142 connected to two opposite ends of the overall tube rows. More specifically, the first and second header tanks 141 and 142 are connected to the two opposite ends of the tube rows and each have a partition wall that divides a fluid flow space into a front space and a rear space. Meanwhile, the tube rows are configured as two front and rear rows. As illustrated in FIG. 2, the front tube row defines a front core FC and communicates with the front spaces of the first and second header tanks 141 and 142. In addition, as illustrated in FIG. 2, the rear tube row also defines a rear core BC and communicates with the rear spaces of the first and second header tanks 141 and 142. FIG. 2 is a schematic view. Although not illustrated to simplify the drawings, the composite heat exchanger 100 may include an integrated fin. The integrated fin is interposed between the tubes and extends to the front core FC and the rear core BC. The integrated fin, together with the first and second header tanks 141 and 142, serves to integrate the front core FC and the rear core BC.

In this case, as properly illustrated in the schematic view in FIG. 2, in the composite heat exchanger 100 of the present invention, the front and rear cores FC and BC are divided into three areas including first, second, and third heat exchange parts 110, 120, and 130. More specifically, a part of the front core FC defines the first heat exchange part 110 in which a coolant flows, the remaining part of the front core FC defines the second heat exchange part 120 in which a refrigerant flows, and the rear core BC defines a third heat exchange part 130 in which a separate heat exchange medium flows. As described below in more detail, a refrigerant flows in the rear core BC in a second embodiment, and a coolant flows in the rear core BC in a third embodiment.

In the composite heat exchanger 100 of the present invention, the coolant flows in the first heat exchange part 110, and the refrigerant flows in the second heat exchange part 120. In particular, in the present invention, the second heat exchange part 120 defines a refrigerant supercooling area in which the refrigerant is supercooled. As described below in more detail, the refrigerant flows in the rear core BC in the second embodiment, and the second heat exchange part 120 and the third heat exchange part 130 are connected through a receiver dryer. Meanwhile, in the third embodiment, the coolant flows in the rear core BC, and an external condenser is connected so that the refrigerant is supercooled in the second heat exchange part 120.

Because the refrigerant is always supercooled in the second heat exchange part 120 as described above, a relatively low temperature is generated in the second heat exchange part 120. Therefore, the second heat exchange part 120 may be disposed at a lower side. Therefore, as illustrated in FIG. 2, in the composite heat exchanger 100, the first heat exchange part 110 may be defined by a part of an upper side of the front core FC, and the second heat exchange part 120 may be defined by a part of a lower side of the front core FC.

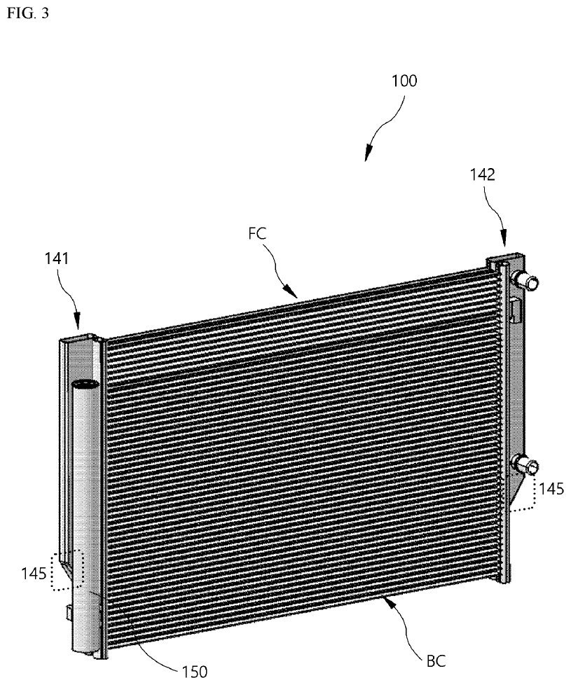

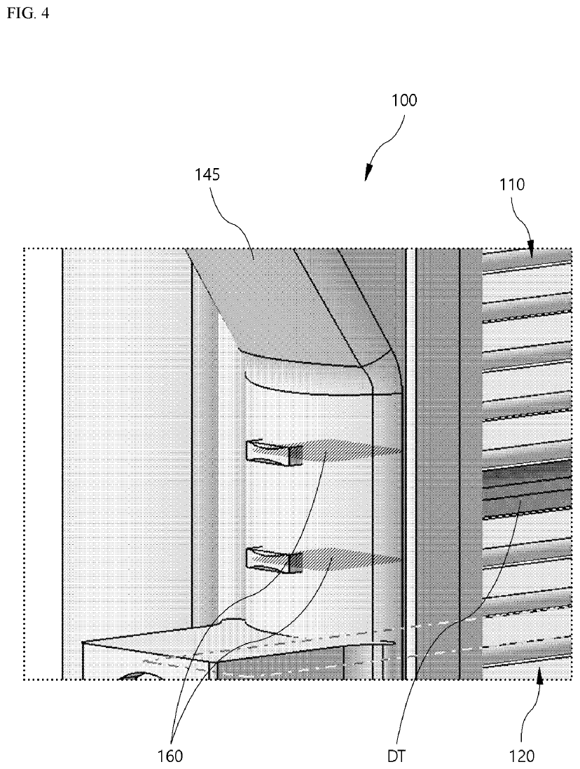

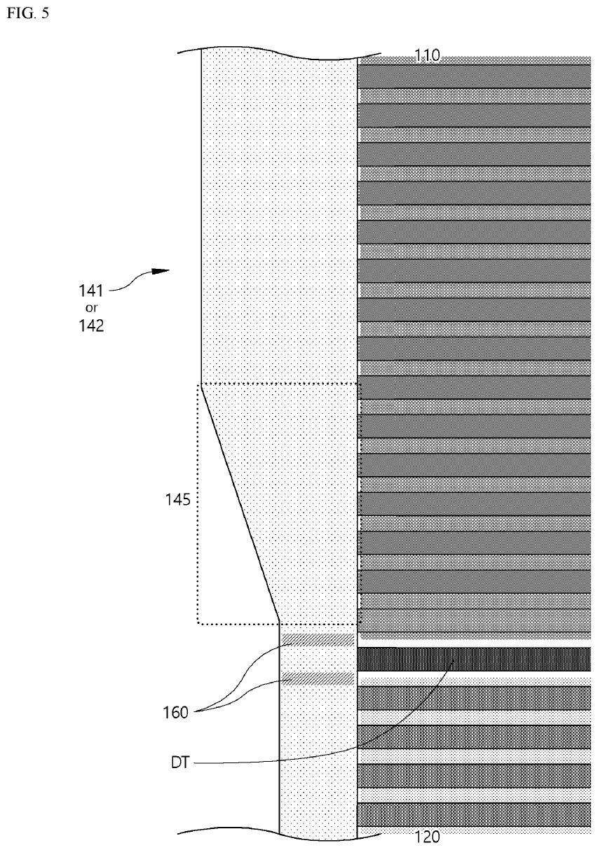

FIG. 3 illustrates a first embodiment of the composite heat exchanger of the present invention, and FIGS. 4 and 5 respectively illustrate enlarged and detailed configurations in the vicinity of an inclined portion of the first embodiment of the composite heat exchanger of the present invention. First, more specifically, some of the components of the first embodiment illustrated in FIGS. 3 to 5 are omitted from the drawings for explaining the second and third embodiments. This is to emphasize the features of the respective embodiments. Because the present invention is not limited by the drawings, the configuration of the first embodiment to be described in section [1] may be entirely applied to the second and third embodiments to be described below in sections [2] and [3]. Further, FIG. 3 illustrates a configuration in which a receiver dryer 150 is also integrated with the composite heat exchanger 100. However, the composite heat exchanger 100 need not necessarily include the receiver dryer 150. This configuration will be described below in more detail in section [3].

First, a configuration of baffles 160 will be described. The baffles 160 are provided in the first header tank 141 and the second header tank 142 and serve to isolate spaces. In this case, as illustrated in FIGS. 4 and 5, the baffle 160 is provided at a boundary position between the first heat exchange part 110 and the second heat exchange part 120 and serves to isolate the fluid flow space for the coolant and the fluid flow space for the refrigerant.

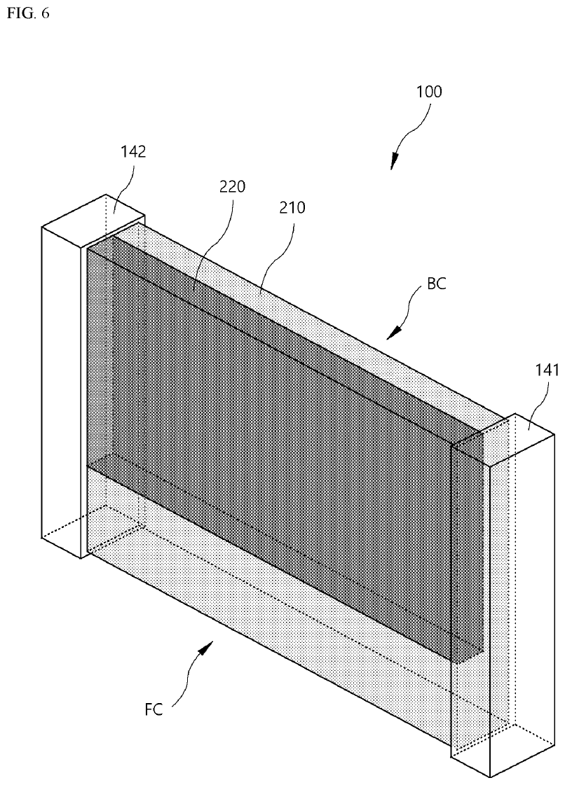

Only a single baffle 160 may be provided. However, as illustrated in FIGS. 5 and 6, a plurality of baffles 160 may be provided. The plurality of baffles 160 is provided to more assuredly prevent a leak of the coolant or refrigerant. Even though any one of the plurality of baffles 160 partially leaks, the remaining baffles may isolate the spaces. In case that the plurality of baffles 160 is provided, the plurality of baffles 160 may be spaced apart from one another in extension directions of the first and second header tanks 141 and 142. With the above-mentioned configuration, even though the heat exchange medium leaks, the leaking heat exchange medium remains in spaces defined between the plurality of baffles 160 and does not obstruct the overall flows of the heat exchange media.

The interiors of the first and second header tanks 141 and 142 are divided by the baffles 160, such that the first and second heat exchange parts 110 and 120 are separated. Therefore, the positions of the baffles 160 may be substantially considered as the boundary positions between the first and second heat exchange parts 110 and 120. However, in this case, as described above, the coolant flows in the first heat exchange part 110, and the refrigerant not only flows in the second heat exchange part 120 but also is supercooled in the second heat exchange part 120. Therefore, there is a significant difference in operating temperature ranges between the first and second heat exchange parts 110 and 120. Therefore, there is a risk that thermal stress is concentrated on the boundary position between the first and second heat exchange parts 110 and 120, and damage occurs because of the concentration of thermal stress. In order to eliminate the risk, the plurality of baffles 160 may be provided to be spaced apart from one another, and a dummy tube DT, which has a closed interior, may be provided between the plurality of baffles 160 spaced apart from one another. Because the heat exchange medium does not flow through the dummy tube DT, the areas, which have temperature differences therebetween, are spaced apart from each other by a range in which the dummy tube DT is present. Therefore, thermal stress may be dispersed to some extent, and a risk of damage may be further reduced.

Meanwhile, as properly illustrated in the drawings, in the composite heat exchanger 100 of the present invention, the first and second header tanks 141 and 142 are not equal in height to one another as a whole, but a high-height portion, which has a relatively high height, and a low-height portion, which has a low height, are formed in accordance with the range. In particular, in the present invention, the high-height portion is included in a range corresponding to the first heat exchange part 110, and the low-height portion is included in a range corresponding to the second heat exchange part 120. That is, intuitively, in the first and second header tanks 141 and 142 adjacent to the front core FC, the portion, through which the coolant flows, has a higher height than the portion through which the refrigerant flows. Considering that the refrigerant and the coolant are different in physical properties and thus different in flow resistance and the like, the coolant flowing portion and the refrigerant flowing portion may have appropriately different dimensions, as necessary, instead of the same dimension. In particular, generally, pressure in the refrigerant flowing portion is slightly higher than pressure in the coolant flowing portion. Therefore, pressure resistance needs to be considered more important at the time of designing the refrigerant flowing portion. In order to increase pressure resistance, a cross-sectional shape needs to be closer to a circular shape, i.e., a difference between horizontal and vertical heights of the cross-section needs to be small. Therefore, the refrigerant flowing portion may be maintained to be in an original state in which horizontal and vertical heights of the cross-section are similar to each other, but the coolant flowing portion is free from this restriction. In the composite heat exchanger 100 of the present invention, the height of the coolant flowing portion is higher than the height of the refrigerant flowing portion in consideration of the above-mentioned factors, flow resistance, flow path configurations, pressure resistance for each portion, and the like.

In case that the heights of the coolant and refrigerant flowing portions are different from one another, the height may change vertically. However, in the case of a shape in which the height is rapidly changed, there is a risk that a defect occurs during the manufacturing process, and damage occurs because of concentration of stress even during the operation. In consideration of these factors, an inclined portion 145 may be formed in the portion where the heights of the coolant and refrigerant flowing portions are different from one another. The inclined portion 145 is disposed between the high-height portion and the low-height portion and has a height that changes continuously and inclinedly. The inclined portion 145 is properly illustrated in all FIGS. 3 to 5.

In this case, as illustrated in FIGS. 3 to 5 consistently, the high-height portion and the inclined portion 145 may be included in the range corresponding to the first heat exchange part 110. The reason why the high-height portion and the inclined portion 145 are included in the range corresponding to the first heat exchange part 110 will be described below in more detail. As described above, the baffle 160 is provided on the boundary position between the first and second heat exchange parts 110 and 120. In case that the baffle 160 is provided in the inclined portion 145, the shape of the inclined portion 145 is not consistent, which may increase a risk of the occurrence of a leak caused by an assembling defect or the like. In order to prevent the problem, the baffle 160 may be disposed to be out of the range of the inclined portion 145. In other words, the inclined portion 145 may be formed to be included in the first heat exchange part 110 or included in the second heat exchange part 120.

Meanwhile, because the second heat exchange part 120 is used to supercool the refrigerant, the second heat exchange part 120 may have a relatively small capacity. In contrast, the first heat exchange part 110 needs to have a relatively large capacity because the first heat exchange part 110 operates as a radiator as the coolant flows through the first heat exchange part 110. That is, the first heat exchange part 110 has a larger volume. In order for the inclined portion 145 to have a sufficient volume, the inclined portion 145 may be formed to be included in the first heat exchange part 110 instead of the second heat exchange part 120.

As a result, the inclined portion 145 may be formed to be included in the first heat exchange part 110. In this case, the baffle 160 may be disposed to be naturally out of the range of the inclined portion 145. In this case, as a result, the high-height portion and the inclined portion 145 are included in the range corresponding to the first heat exchange part 110. Strictly, the first heat exchange part 110 includes the high-height portion, the inclined portion 145, and a part of the low-height portion adjacent to the baffle 160, and the second heat exchange part 120 includes only the low-height portion.

Meanwhile, in this case, as a result, the baffle 160 is disposed adjacent to the low-height portion, i.e., the second heat exchange part 120. There is another consideration related to the configuration in which the baffle 160 is disposed adjacent to the second heat exchange part 120. As described above, the pressure resistance needs to be additionally considered because pressure in the refrigerant flowing portion is higher than pressure in the coolant flowing portion. This also means that a likelihood of a leak of the refrigerant is higher in the refrigerant flowing portion. In addition, a height of the header tank in the refrigerant flowing portion is lower than that in the coolant flowing portion, which facilitates the sealing. In view of this situation, it is more advantageous for the overall stability of the device to block a leak of the refrigerant. Therefore, the plurality of baffles 160 may be provided adjacent to the refrigerant flowing portion, i.e., the second heat exchange part 120.

Because the heights of the first and second header tanks 141 and 142 are not uniform as described above, the first and second header tanks 141 and 142 are not integrally manufactured by extrusion, but may each include a header connected directly to the tube row, and a tank coupled to the header and configured to define the fluid flow space. With the above-mentioned structure, it is possible to more easily manufacture the shape of the header tank having the height that varies depending on the position.

### [2] Second Embodiment: Integration of Condenser and Receiver Dryer

As described in section [1], the composite heat exchanger 100 of the present invention includes the front core FC and the rear core BC, and the front core FC includes the first heat exchange part 110 in which the coolant flows, and the second heat exchange part 120 in which the refrigerant flows and is supercooled. Meanwhile, a desired heat exchange medium may flow in the third heat exchange part 130 in accordance with the user's necessity. In the second embodiment, the refrigerant flows in the third heat exchange part 130, and the third heat exchange part 130 defines a refrigerant condensation area C in which the refrigerant is condensed.

FIG. 6 is a schematic configuration view of the second embodiment of the composite heat exchanger of the present invention. In the second embodiment, the refrigerant supercooling area S, which is formed by the second heat exchange part 120, and the refrigerant condensation area C, which is formed by the third heat exchange part, are defined as a condenser 210. The first heat exchange part 110 defines a coolant area W in which the coolant is cooled, and the coolant area W is defined as a radiator 220. For ease of understanding, FIG. 6 illustrates only the distinction between the condenser 210 and the radiator 220.

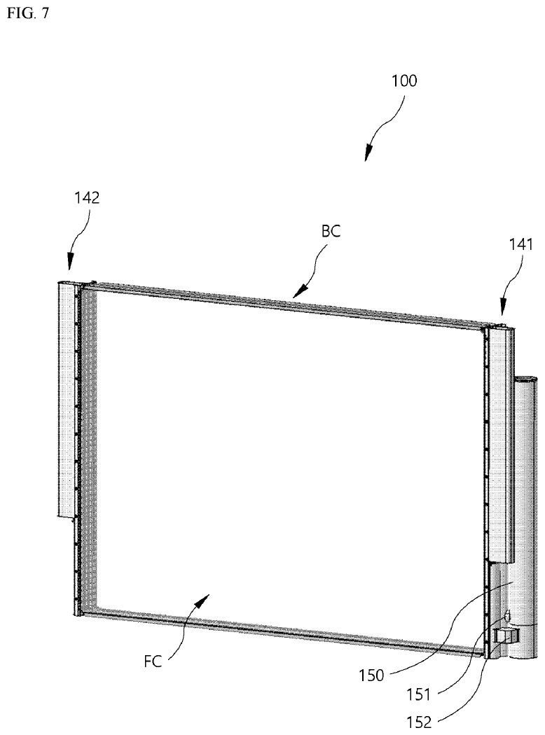

When the composite heat exchanger 100 is configured as a heat exchanger integrated with the condenser 210 and the radiator 220 as described above, the composite heat exchanger 100 may include the receiver dryer 150 connected to the first header tank 110. FIG. 7 illustrates the composite heat exchanger 100 including the receiver dryer 150. The receiver dryer 150 communicates with the rear space of the first header tank 141 through a receiver inlet path 151 and communicates with the front space of the first header tank 141 through a receiver outlet path 152. That is, in the composite heat exchanger 100 of the present invention, the condenser 210, the radiator 220, and the receiver dryer 150 are integrated.

In this case, even in the case of the condenser and the radiator, the condenser 210 and the radiator 220 may be integrated while appropriately separating the flow spaces of the two-row heat exchanger, thereby improving productivity by basically excluding the component and process required to manufacture and assemble a condenser and a radiator in the related art in which the condenser and the radiator are configured as separate components. Furthermore, the single integrated component may more easily reduce the volume and further improve spatial utilization of an engine room in comparison with the assembly including two separate components.

In the second embodiment, not only the condenser 210 and the radiator 220 are integrated, but also the receiver dryer 150 is integrated. That is, as illustrated in FIG. 7, the receiver dryer 150 is disposed adjacent to the first header tank 141 and communicates with the first header tank 141 through the receiver inlet path 151 and the receiver outlet path 152, such that the receiver dryer 150 is further integrated with the condenser 210 and the radiator 220. Therefore, the effect of reducing the number of components and processes, improving the productivity, reducing the volume of the device, and improving the spatial utilization of the engine room is further improved.

Further, in the present invention, as properly illustrated in FIG. 7, a length of the flow path connecting the receiver dryer 150 and the first header tank 141 is very short. Therefore, the configuration of the present invention basically solves the problem in the related art in which the pipe connecting the condenser and the receiver dryer is excessively long, and the amount of pressure drop of the refrigerant increases, which eventually degrades the cooling efficiency.

In addition, the composite heat exchanger 100 of the present invention is more effective when the composite heat exchanger 100 is applied to the electric vehicle. This is because the amount of heat generation in the drive device is relatively small (smaller than that in the internal combustion engine vehicle) and the operating temperature range of the refrigerant in the condenser and the operating temperature range of the coolant in the radiator are relatively similar. In case that a temperature gradient deviation is excessively large in a single device, there is concern that the performance of the device somewhat deteriorates. However, because a temperature gradient deviation is properly adjusted in the case of the electric vehicle, the concern may be significantly reduced.

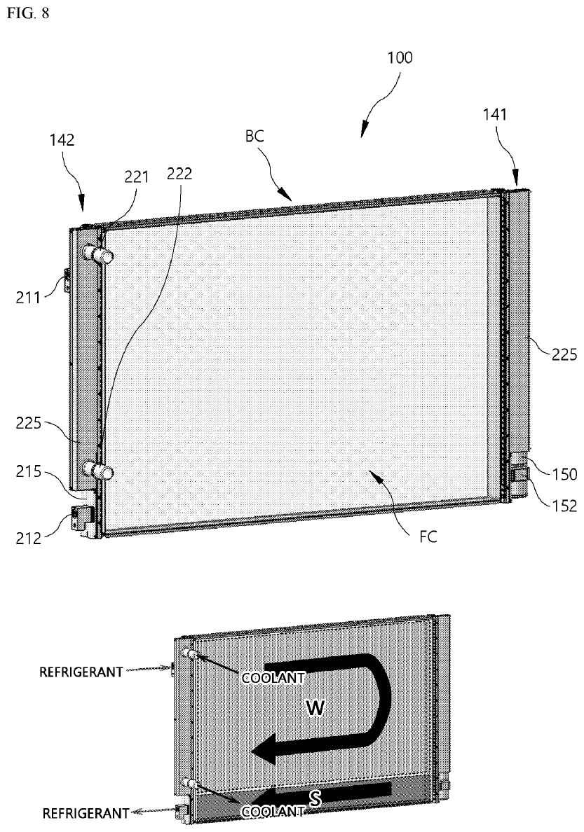

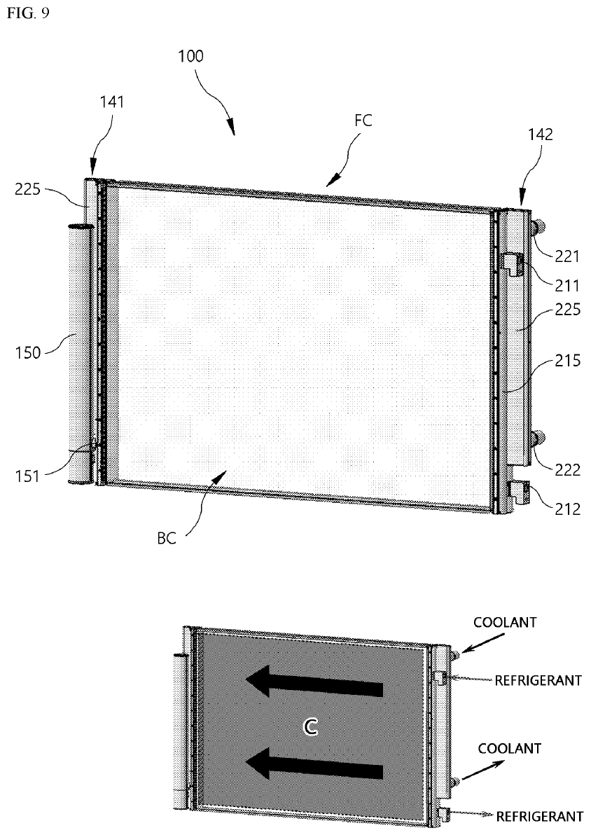

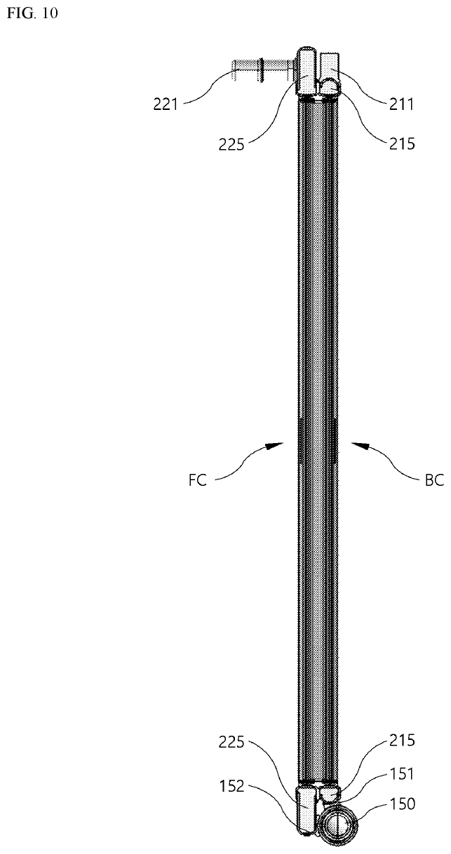

Hereinafter, the configuration of the composite heat exchanger 100 of the present invention and the flow of fluids will be described in more detail with reference to the front perspective view in FIG. 8, the rear perspective view in FIG. 9, and the top plan view in FIG. 10.

FIGS. 8 and 9 illustrate how the refrigerant and the coolant separately flow to the area of the front core FC and the area of the rear core BC. First, with reference to FIG. 9, the refrigerant flows through the entire rear core BC and defines the refrigerant condensation area C. With reference to FIG. 8, the refrigerant flows through a part of the lower side of the front core FC and defines the refrigerant supercooling area S. As described above, the refrigerant condensation area C and the refrigerant supercooling area S define the condenser 210. In addition, with reference to FIG. 8, the coolant flows through the remaining part of the upper side of the front core FC and defines the coolant area W. The coolant area W defines the radiator 220. With reference to the top plan view of the composite heat exchanger 100 illustrated in FIG. 10, the forward and rearward arrangement of the respective components may be more intuitively understood.

Further, as described above, both the refrigerant and the coolant flow through the first and second header tanks 141 and 142. The portion of each of the first and second header tanks 141 and 142 where the refrigerant flows is also called a refrigerant tank part 215, and the portion where the coolant flows is also called a coolant tank part 225. That is, both the first and second header tanks 141 and 142 are divided into the refrigerant tank part 215 having the range corresponding to the refrigerant condensation area C and the refrigerant supercooling area S, and the coolant tank part 225 having the range corresponding to the coolant area W. The configuration will be more specifically described in order to avoid confusion. Both the refrigerant tank part 215 and the coolant tank part 225 are present in the first header tank 141, and both the refrigerant tank part 215 and the coolant tank part 225 are also present in the second header tank 142.

The configuration and operation of the condenser 210 will be more specifically described below in accordance with the flow of the refrigerant with reference to FIGS. 8 and 9. First, the refrigerant introduced into a refrigerant inlet path 211 that communicates with the rear space of the second header tank 142. Next, the refrigerant is delivered from the rear space of the second header tank 142 to the rear space of the first header tank 141 while passing through the refrigerant condensation area C in the rear core BC. Next, the refrigerant is delivered from the rear space of the first header tank 141 to the front space of the first header tank 141 via the receiver inlet path 151 and the receiver outlet path 152 while passing through the receiver dryer 150. Next, the refrigerant is delivered from the front space of the first header tank 141 to the front space of the second header tank 142 while passing through the refrigerant supercooling area C in the front core FC. Lastly, the refrigerant is discharged to a refrigerant outlet path 212 that communicates with the front space of the second header tank 142. That is, the refrigerant sequentially passes through the refrigerant condensation area C (at the rear side), the receiver dryer 150, and the refrigerant supercooling area S (at the front side).

When the high-temperature, high-pressure gaseous refrigerant passes through the refrigerant condensation area C, the refrigerant is condensed into a liquid state by exchanging heat with outside air. In this case, because the overall amount of refrigerant cannot be condensed, the refrigerant discharged from the refrigerant condensation area C is in the state in which the gaseous refrigerant and the liquid refrigerant are mixed. As the refrigerant in this state passes through the receiver dryer 150, bubbles contained in the liquid refrigerant is filtered out, such that the gaseous refrigerant and the liquid refrigerant are separated. The liquid refrigerant is introduced into the refrigerant supercooling area S and supercooled.

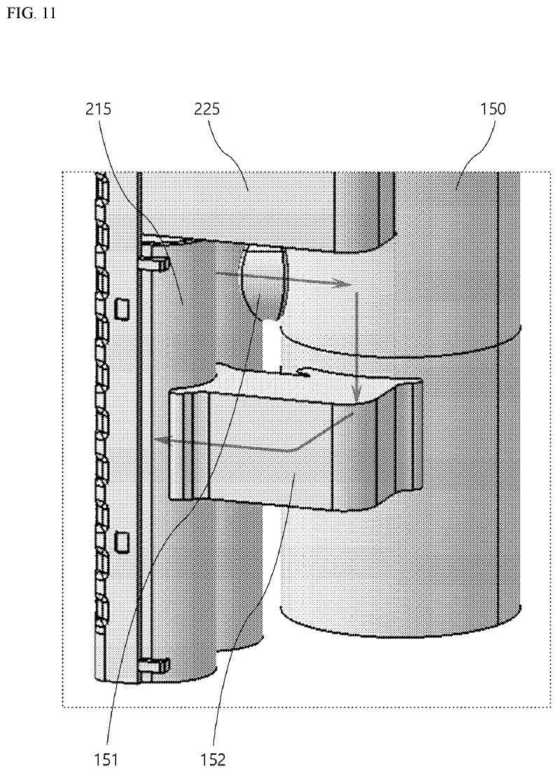

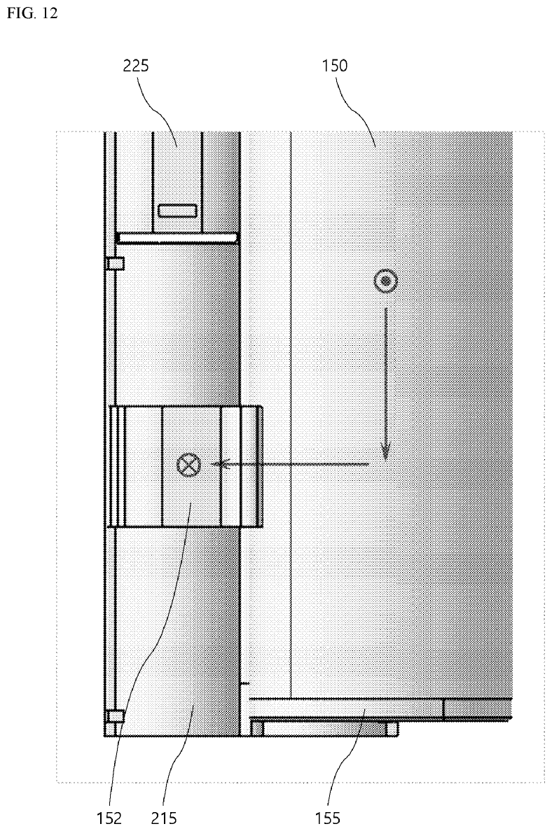

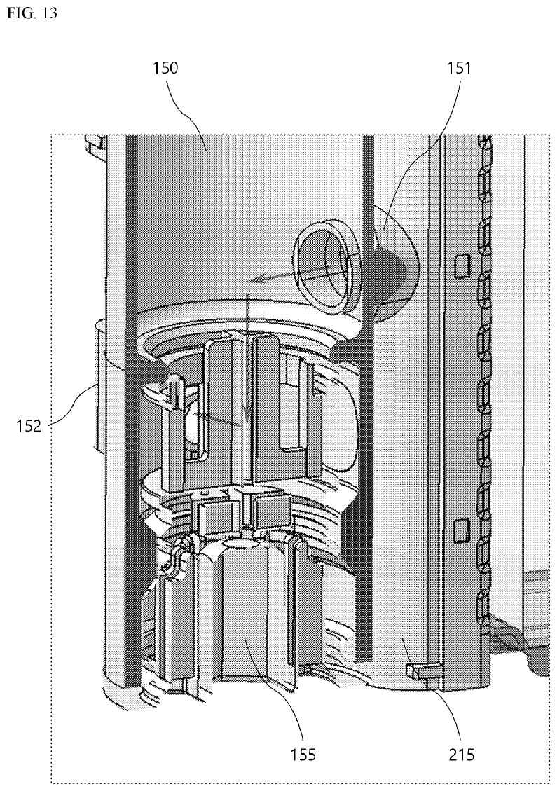

In this case, the configuration and operation of the receiver dryer 150 will be more specifically described below. FIG. 11 is a front perspective view of a part of the receiver dryer, FIG. 12 is a side view of a part of the receiver dryer, and FIG. 13 is a rear perspective cross-sectional view of a part of the receiver dryer. As explicitly illustrated in FIGS. 11 and 12, the refrigerant is introduced into the receiver dryer 150 along the receiver inlet path 151 from the front space of the first header tank 141, and the refrigerant is discharged to the rear space of the first header tank 141 along the receiver outlet path 152 from the receiver dryer 150. The shape of the receiver outlet path 152 will be more specifically described. As properly illustrated in FIG. 11, one side of the receiver outlet path 152 is connected to a front side of the receiver dryer 150, extends forward, and then is bent vertically, and the other side of the receiver outlet path 152 is connected to the front space of the first header tank 141. In this case, as explicitly illustrated in the drawings, the receiver inlet path 151 and the receiver outlet path 152 are very short, thereby maximally suppressing an increase in amount of pressure drop of the refrigerant.

Meanwhile, as illustrated in FIG. 12, the receiver dryer 150 may have a filter module 155 having a filter and a drying agent, and the filter module 155 is detachably provided. As described above, the filter module 155 only needs to be replaced even though the filtering performance somewhat deteriorates as the receiver dryer 150 operates over a long period of time in the state in which the receiver dryer 150 is integrated with the composite heat exchanger 100. Therefore, it is possible to greatly save resources such as time, attractive forces, costs, and the like required for repair.

An example of the filter module 155 assembled to the receiver dryer 150 is illustrated in the rear perspective cross-sectional view in FIG. 13. Because the filter module 155 includes the filter configured to filter out bubbles, and the drying agent configured to remove moisture, it is naturally preferable that the refrigerant delivered from the refrigerant condensation space C passes through the filter module 155 in large amount and then is delivered to the refrigerant supercooling space S. Therefore, as illustrated in FIG. 13, refrigerant inlet and outlet routes on the receiver dryer 150, i.e., the receiver inlet path 151 and the receiver outlet path 152 in the second embodiment are formed in an area range in which the filter module 155 is provided.

The configuration and operation of the radiator 220 will be more specifically described below in accordance with the flow of the coolant with reference back to FIG. 8. First, the coolant is introduced into a coolant inlet path 212 that communicates with the front space of the second header tank 142. Next, the coolant is delivered from the front space of the second header tank 142 to the front space of the first header tank 141 while passing through a part of the coolant area W in the front core FC. Next, the coolant is delivered from the front space of the first header tank 141 to the front space of the second header tank 142 while passing through the remaining part of the coolant area W in the front core FC. Lastly, the coolant is discharged to a coolant outlet path 222 that communicates with the front space of the second header tank 142. That is, the coolant flows while forming a U flow in the coolant area W.

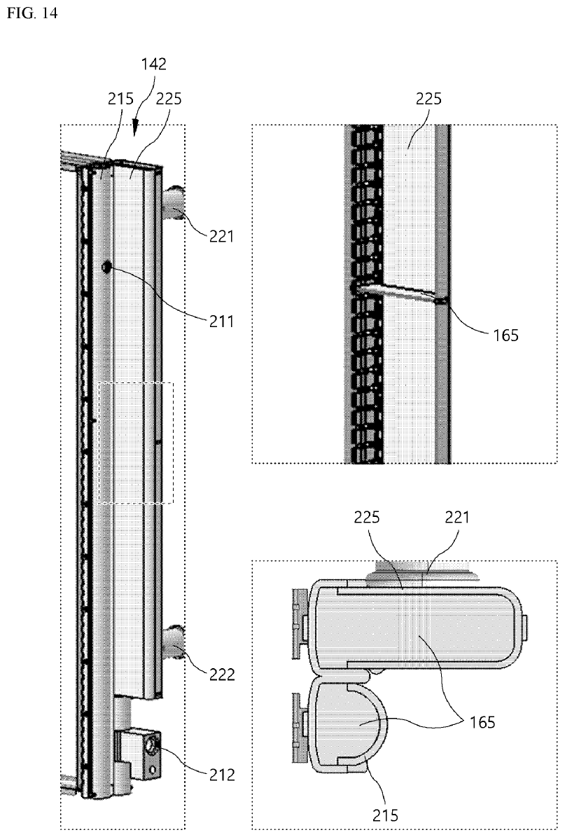

In order for the coolant to form the U flow, a flow path baffle 165 may be provided on a middle portion of the second header tank 142. FIG. 14 is a detailed view of the tank part, and the left view is an enlarged view of the second header tank 142 in the rear perspective view in FIG. 9. The right upper view is an enlarged view of the part indicated by the quadrangular broken line in the left view and illustrates the interior of the second header tank 142 by removing a part of the second header tank 142. As explicitly illustrated in the left upper view in FIG. 14, the flow path baffle 165 is provided on the middle portion of the second header tank 142, such that the U flow of the coolant illustrated in FIG. 8 may be smoothly formed. The right lower view in FIG. 14 is a cross-sectional view of the second header tank 142 at a position on the flow path baffle 165.

Meanwhile, as described above in section [1], i.e., the first embodiment, the baffle 160 is provided to isolate the coolant/refrigerant flow spaces (i.e., separate the first and second heat exchange parts). Substantially, the baffles perform the same basic function of dividing the space in the header tank, but the detailed functions may vary depending on [whether the baffle divides the heat exchange part] by dividing the space or [whether the baffle forms the U flow] by dividing the space. Therefore, for the distinction from the baffle that is denoted by reference numeral 160 and serves to [divide the heat exchange part] in section [1], i.e., the first embodiment, the baffle for [forming the U flow] is referred to as a “flow path baffle” (as a meaning of the ‘baffle for forming the flow path’) and denoted by reference numeral 165.

More specifically, as described above, the first and second header tanks 141 and 142 communicate with all the coolant area W, in which the coolant flows, and the refrigerant condensation area C and the refrigerant supercooling area S, in which the refrigerant flows, and thus the first and second header tanks 141 and 142 respectively have the refrigerant tank part 215 and the coolant tank part 225. In this case, it is apparent that the coolant/refrigerant flow spaces need to be isolated on the boundary position between the coolant area W and the refrigerant supercooling area S in order to distinguish the refrigerant tank part 215 and the coolant tank part 225. The arrangement position of the baffle 160 and the number of baffles 160, which have been described in section [1], i.e., the first embodiment, relate to the isolation of the coolant/refrigerant flow spaces. Because this part follows the configuration in section [1], i.e., the first embodiment in an intact manner, a further design thereof will be omitted.

Further, in the drawings of the second embodiment, i.e., FIGS. 6 to 14, a height change portion between the refrigerant tank part 215 and the coolant tank part 225 is illustrated as being vertically formed. However, the present invention is not limited thereto. The configuration of the inclined portion 145 described in the first embodiment may also be applied to the second embodiment in an intact manner. Further, other various configurations in the first embodiment, i.e., the configuration in which the plurality of baffles 160 is disposed, the configuration in which the inclined portion 145 is formed adjacent to the first heat exchange part 110 (i.e., the coolant tank part 225 described as the term in the second embodiment), the configuration in which the plurality of baffles 160 is formed adjacent to the second heat exchange part 120 (i.e., the refrigerant tank part 215 described as the term in the second embodiment) in an opposite manner, and the configuration in which the dummy tube DT is provided in the vicinity of the position on the baffle 160 may, of course, be applied to the second embodiment in an intact manner.

### [3] Third Embodiment: Integration of Cold Air, High-Temperature, and Low-Temperature Radiator

As described in section [1], the composite heat exchanger 100 of the present invention includes the front core FC and the rear core BC, and the front core FC includes the first heat exchange part 110 in which the coolant flows, and the second heat exchange part 120 in which the refrigerant flows and is supercooled. Meanwhile, a desired heat exchange medium may flow in the third heat exchange part 130 in accordance with the user's necessity. In the third embodiment, the coolant flows in the third heat exchange part 130, and the temperature range of the coolant flowing in the first heat exchange part 110 and the temperature range of the coolant flowing in the third heat exchange part 130 are different from each other.

For example, as described above, in case that the drive device is a hybrid drive device that uses both the internal combustion engine and the electric motor, both the internal combustion engine and the electric motor are cooled by coolants, but the coolant for the internal combustion engine has a much higher temperature than the coolant for the electric motor. That is, in this case, a high-temperature coolant and a low-temperature coolant are present, and therefore, a high-temperature radiator and a low-temperature radiator are sometimes provided as separate devices. In the third embodiment, the high-temperature radiator and the low-temperature radiator may be integrated.

More specifically, in the third embodiment, the temperature range of the coolant flowing in the third heat exchange part 130 is higher than the temperature range of the coolant flowing in the first heat exchange part 110. That is, the first heat exchange part 110 operates as a low-temperature radiator, and the third heat exchange part 130 operates as a high-temperature radiator. The high-temperature radiator and the low-temperature radiator are integrated as described above, which makes it possible to obtain the above-mentioned effect of reducing the number of components and assembling processes by virtue of the integration described in the second embodiment.

Meanwhile, in this case, in order for the second heat exchange part 120 to operate as the refrigerant supercooling area, an external condenser is connected to the second heat exchange part 120 of the composite heat exchanger 100, such that the refrigerant condensed in the external condenser may be introduced into the second heat exchange part 120, and the refrigerant may be supercooled. In this case, the external condenser may be a water-cooled condenser and be a kind of heat exchanger that cannot be integrated with the composite heat exchanger 100 of the present invention that is basically an air-cooled condenser. In case that the external condenser is connected to the second heat exchange part 120 as described above, the external condenser may be integrated with an external receiver dryer (that is a receiver dryer provided separately from the receiver dryer 150 described in the second embodiment.

Further, as in the second embodiment, the configurations in the first embodiment, i.e., the configuration in which the heights of the coolant/refrigerant flowing portions in the first and second header tanks 141 and 142 are different from one another, the configuration of the inclined portion 145, the configuration in which the plurality of baffles 160 is disposed, the configuration in which the inclined portion 145 is formed adjacent to the first heat exchange part 110, the configuration in which the plurality of baffles 160 is formed adjacent to the second heat exchange part 120 in the opposite manner, and the configuration in which the dummy tube DT is provided in the vicinity of the position on the baffle 160 may, of course, be applied to the third embodiment in an intact manner.

The present invention is not limited to the above embodiments, and the scope of application is diverse. Of course, various modifications and implementations made by any person skilled in the art to which the present invention pertains without departing from the subject matter of the present invention claimed in the claims.

### Industrial Applicability

According to the composite heat exchanger for an electric vehicle according to the present invention, it is possible to obtain the effects, by means of integration, such as reducing the number of components and the number of processes, improving refrigerant flow characteristics, and improving cooling efficiency, and in addition, the problem of concentration of thermal stress caused by the integration of the heat exchanger may be resolved by means of improving the shape of the area boundary.

What is claimed is:

1. A composite heat exchanger comprising:
a plurality of tubes disposed in two front and rear rows;
first and second header tanks connected to two opposite ends of the overall tube rows and each having a partition wall that divides a fluid flow space into a front space and a rear space;
a front core defined by a front tube row and configured to communicate with the front spaces of the first and second header tanks; and
a rear core defined by a rear tube row and configured to communicate with the rear spaces of the first and second header tanks,
wherein a part of the front core defines a first heat exchange part in which a coolant flows,
wherein the remaining part of the front core defines a second heat exchange part in which a refrigerant flows, and
wherein the rear core defines a third heat exchange part in which a separate heat exchange medium flows.

2. The composite heat exchanger of claim 1, wherein the second heat exchange part of the composite heat exchanger defines a refrigerant supercooling area in which the refrigerant is supercooled.

3. The composite heat exchanger of claim 2, wherein the first heat exchange part of the composite heat exchanger is defined by a part of an upper side of the front core, and the second heat exchange part is defined by a part of a lower side of the front core.

4. The composite heat exchanger of claim 2, wherein baffles are provided in the first and second header tanks of the composite heat exchanger so that fluid flow spaces for the coolant and the refrigerant are isolated on a boundary position between the first and second heat exchange parts.

5. The composite heat exchanger of claim 4, wherein the baffle is provided as a plurality of baffles provided on the boundary position between the first and second heat exchange parts of the composite heat exchanger, and
wherein the plurality of baffles is spaced apart from one another in extension directions of the first and second header tanks, and a dummy tube having a closed interior is provided between the plurality of baffles spaced apart from one another.

6. The composite heat exchanger of claim 4, wherein the first and second header tanks each have a high-height portion having a relatively high height and a low-height portion having a relatively low height in accordance with a range, and
wherein the high-height portion is included in a range corresponding to the first heat exchange part, and the low-height portion is included in a range corresponding to the second heat exchange part.

7. The composite heat exchanger of claim 6, wherein the first and second header tanks each have an inclined portion formed between the high-height portion and the low-height portion and having a height that changes continuously and inclinedly, and the high-height portion and the inclined portion are included in a range corresponding to the first heat exchange part.

8. The composite heat exchanger of claim 2, wherein the refrigerant flows in the third heat exchange part of the composite heat exchanger, and the third heat exchange part defines a refrigerant condensation area in which the refrigerant is condensed.

9. The composite heat exchanger of claim 8, wherein the composite heat exchanger comprises a receiver dryer including a receiver inlet path configured to communicate with the rear space of the first header tank, and a receiver outlet path configured to communicate with the front space of the first header tank,
wherein the refrigerant supercooling area defined by the second heat exchange part and the refrigerant condensation area defined by the third heat exchange part are defined as a condenser,
wherein the first heat exchange part defines a coolant area in which the coolant is cooled, and the coolant area is defined as a radiator, and
wherein the condenser, the radiator, and the receiver dryer are integrated.

10. The composite heat exchanger of claim 9, wherein the composite heat exchanger is formed such that the refrigerant is introduced into a refrigerant inlet path communicating with the rear space of the second header tank and delivered from the rear space of the second header tank to the rear space of the first header tank while passing through the refrigerant condensation area in the rear core, the refrigerant is delivered from the rear space of the first header tank to the front space of the first header tank via the receiver inlet path and the receiver outlet path while passing through the receiver dryer, the refrigerant is delivered from the front space of the first header tank to the front space of the second header tank while passing through the refrigerant supercooling area in the front core, and the refrigerant is discharged to a refrigerant outlet path communicating with the rear space of the second header tank.

11. The composite heat exchanger of claim 9, wherein the composite heat exchanger is formed such that the coolant is introduced into a coolant inlet path communicating with the front space of the second header tank, the coolant is delivered from the front space of the second header tank to the front space of the first header tank while passing through a part of the coolant area in the front core, the coolant is delivered from the front space of the first header tank to the front space of the second header tank while passing through the remaining part of the coolant area in the front core, and the coolant is discharged to a coolant outlet path communicating with the front space of the second header tank.

12. The composite heat exchanger of claim 9, wherein one side of the receiver outlet path is connected to a front side of the receiver dryer, extends forward, and then is bent vertically, and the other side of the receiver outlet path is connected to the front space of the first header tank.

13. The composite heat exchanger of claim 2, wherein the coolant flows in the third heat exchange part of the composite heat exchanger, and a temperature range of the coolant flowing in the first heat exchange part and a temperature range of the coolant flowing in the third heat exchange part are different from each other.

14. The composite heat exchanger of claim 13, wherein a temperature range of the coolant flowing in the third heat exchange part of the composite heat exchanger is higher than a temperature range of the coolant flowing in the first heat exchange part.

15. The composite heat exchanger of claim 13, wherein an external condenser is connected to the second heat exchange part of the composite heat exchanger, the refrigerant condensed in the external condenser is introduced into the second heat exchange part, and the refrigerant is supercooled.

16. The composite heat exchanger of claim 15, wherein the external condenser is a water-cooled condenser.

17. The composite heat exchanger of claim 15, wherein the external condenser is integrated with an external receiver dryer.

18. The composite heat exchanger of claim 1, wherein the receiver dryer has a filter module having a filter and a drying agent, and the filter module is detachably provided.

19. The composite heat exchanger of claim 18, wherein in the receiver dryer, refrigerant inlet and outlet routes on the receiver dryer are provided in an area range in which the filter module is provided.

20. The composite heat exchanger of claim 1, wherein the composite heat exchanger comprises an integrated fin interposed between the tubes and extends to the front core and the rear core.
